(19) United States
(12) Patent Application Publication
(10) Pub. No.: US 2007/0089060 A1
(43) Pub. Date: Apr. 19, 2007

(54) Imaged data and time correction apparatus, method, and program

(75) Inventor: Hajime Shirasaka, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/540,551

(22) Filed: Oct. 2, 2006

(30) Foreign Application Priority Data
Sep. 30, 2005 (JP) 286777/2005

(51) Int. Cl. G11B 27/00

(52) U.S. Cl. 715/723

(57) ABSTRACT

An apparatus and method for performing collective correction for imaged date and time data attached to image data files obtained by a selected imaging device among image data files obtained by a plurality of imaging devices. Image data files obtained by a plurality of imaging devices, and imaged date and time data attached to each of the image data files are downloaded; and when either one of the imaging devices is selected by the user, and an amount of correction for correcting the imaged date and time data of the image data files obtained by the selected imaging device is inputted, the imaged date and time data attached to the image data files obtained by the selected imaging device are equally corrected based on the amount of correction.

### BACKGROUND OF THE INVENTION

1. Field of the Invention

The present invention relates to an imaged date and time correction apparatus and method for equally correcting the imaged date and time of the image data files obtained by a plurality of imaging devices. The present invention further relates to a program for causing a computer to execute the method.

2. Description of the Related Art

When saving a plurality of images obtained by digital cameras, cell phones with digital cameras, and the like, in personal computers or the like to arrange them in order, or to create slide shows using electronic album software or the like, it is customary that the image data are arranged or reproduced as slide shows in chronological order using imaged date and time data appended to the image data files.

Here, the imaged date and time data appended to the image data files are provided based on the date and time set on each digital camera. Assuming, for example, a wedding reception in which wedding cake cutting scenes are imaged serially by a plurality of digital cameras. When all of the images are saved in a single personal computer to create a slide show in chronological order, if the date and time set on one of the digital cameras differs from the others, the cake cutting scenes are not reproduced in the correct order. Further, images obtained abroad by a plurality of digital cameras may not be arranged in correct order of itinerary even if they are saved in a single personal computer and arranged according to the date and time of each of the images, if some of the images were obtained by a digital cameras set at Japan time and the other of which were obtained by another digital camera set at local time.

Consequently, a date and time correction method for correcting the date and time set on a digital camera is proposed as described for example, in Japanese Unexamined Patent Publication No. 2002-044596. In the method, when an image data file is received by an image filing device from an external device (digital camera or the like), the date and time information of the external device is also received, and if the difference in date and time between the received date and time information and the date and time of the image filing device is greater than a predetermined allowable range, the date and time information of the image data file received from the external device connected thereto is overwritten.

Another date and time correction method for correcting the date and time of an image is proposed as described, for example, in Japanese Unexamined Patent Publication No. 2005-117338. In the method, when an image data file is received by an image filing device from an external device, the time synchronization between the image filing device and external device is implemented, and the synchronized timing is recorded. Then, based on the time difference between the image filing device and external device at the time of present synchronized timing and previous synchronized timing, the time difference between the images at the time of imaging is calculated for each image to correct the imaged date and time.

In the methods disclosed in Japanese Unexamined Patent Publication No. 2002-044596 and Japanese Unexamined Patent Publication No. 2005-117338, however, it is customary that the various data are exchanged between the image filing device and external device through the recording medium having the image data recorded thereon, and such recording medium generally has no current time information or the like. Consequently, an additional interface is required for exchanging current time information between the image filing device and external device, causing problems of complicated device configuration and compatibility of the interface.

The present invention has been developed in view of the circumstances described above, and it is an object of the present invention to provide a method and apparatus capable of correcting the difference in the imaged date and time of image data files obtained by a plurality of digital cameras (imaging device).

### SUMMARY OF THE INVENTION

An imaged date and time correction apparatus of the present invention comprises:

an image data downloading means for downloading image data files obtained by a plurality of imaging devices, each file having appended thereto date and time data that indicate the imaged date and time thereof;

a selection means for selecting all of the image data files obtained by either one of the plurality of imaging devices from the downloaded image data files; and

a date and time correction means for equally correcting the date and time data appended to the selected image data files.

Here, a configuration may be adopted in which the apparatus further includes a model identifier display means for displaying a model identifier of each of the plurality of imaging devices; and the selection means receives a selection instruction specifying either one of the displayed model identifiers, and selects all of the image data files obtained by the imaging device corresponding to the specified model identifier.

Further, a configuration may be adopted in which the apparatus further includes an image display means for displaying images based on the downloaded image data files; and the selection means receives a selection instruction specifying either one of the displayed images, and selects all of the image data files obtained by the imaging device that obtained the image data file corresponding to the specified image.

Another imaged date and time correction apparatus of the present invention comprises:

a data downloading means for downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;

a corresponding date and time obtaining means for obtaining a corresponding date and time at the time point where a sound characteristic amount of each of the downloaded sound data files corresponds to each other for each of the sound data files from the recorded date and time data;

a date and time difference detection means for detecting a difference of the corresponding date and time of each of the sound data files based on the obtained corresponding date and time of each of the sound data files; and

a date and time correction means for equally correcting the date and time data appended to the image data files based on the detected difference of the corresponding date and time.

Here, a configuration may be adopted in which the apparatus further includes a selection means for selecting either one of the plurality of imaging devices; the date and time difference detection means detects a time difference between the corresponding date and time of the sound data file obtained by the selected imaging device and the corresponding date and time of the sound data file obtained by another of the imaging devices; and the date and time correction means equally corrects the imaged date and time data appended to the image data files obtained by the another imaging device based on the detected time difference.

An imaged date and time correction method of the present invention comprises the steps of:

downloading image data files obtained by a plurality of imaging devices, each file having appended thereto date and time data that indicate the imaged date and time thereof;

selecting all of the image data files obtained by either one of the plurality of imaging devices from the downloaded image data files; and

equally correcting the date and time data appended to the selected image data files.

Another imaged date and time correction method of the present invention comprises the steps of:

downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;

obtaining means for obtaining a corresponding date and time at the time point where a sound characteristic amount of each of the downloaded sound data files corresponds to each other for each of the sound data files from the recorded date and time data;

detecting a difference of the corresponding date and time of each of the sound data files based on the obtained corresponding date and time of each of the sound data files; and

equally correcting the date and time data appended to the image data files based on the detected difference of the corresponding date and time.

A program according to the present invention is a program for causing a computer to execute the steps of:

downloading image data files obtained by a plurality of imaging devices, each file having appended thereto date and time data that indicate the imaged date and time thereof;

selecting all of the image data files obtained by either one of the plurality of imaging devices from the downloaded image data files; and

equally correcting the date and time data appended to the selected image data files.

Another program of the present invention is a program for causing a computer to execute the steps of:

downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;

obtaining means for obtaining a corresponding date and time at the time point where a sound characteristic amount of each of the downloaded sound data files corresponds to each other for each of the sound data files from the recorded date and time data;

detecting a difference of the corresponding date and time of each of the sound data files based on the obtained corresponding date and time of each of the sound data files; and

equally correcting the date and time data appended to the image data files based on the detected difference of the corresponding date and time.

According to a first embodiment of the present invention, imaged date and time data appended to the image data files obtained by a plurality of imaging devices are corrected by: downloading image data obtained by the plurality of imaging devices; selecting all of the image data obtained by either one of the plurality of imaging devices selected based on the instruction from the user; and equally correcting the date and time data appended to the selected image data files. Thus, the imaged date and time data appended to the image data files obtained by the selected imaging device may be readily corrected. Further, since no interface is required for exchanging information including setting time, current time, and the like, between the imaging device and the imaged date and time correction apparatus, the program of the present invention is operable on the existing imaged date and time correction apparatus by simply installing on the apparatus. That is, there is no need to newly design an imaged date and time correction apparatus, so that the cost for providing the service is minimized.

According to a second embodiment of the present invention, imaged date and time data appended to the image data files obtained by a plurality of imaging devices are corrected using sound data files obtained by the plurality of imaging devices through recording the same sound at the same time by: obtaining a corresponding date and time at the time point where a characteristic amount of each of the sound data files corresponds to each other for each of the sound data flies from the recorded date and time data; calculating a difference of the corresponding data and time of each of the sound data files; and equally correcting the date and time data appended to the image data files based on the detected difference of the corresponding date and time. Thus, the imaged date and time data appended to the image data files may be readily corrected.

### BRIEF DESCRIPTION OF THE DRAWINGS

FIG. 1 is an external view of a print order accepting apparatus.

FIG. 2 is a block diagram of the print order accepting apparatus according to a first embodiment of the present invention, illustrating the functional configuration thereof.

FIG. 3 is a drawing illustration the data structure of the image information in the first embodiment.

FIG. 4 is a flowchart illustrating the flow of the imaged date and time correction process in the first embodiment.

FIGS. 5A, 5B are drawings illustrating example display screens of the display section 3 in the first embodiment.

FIG. 6 is a drawing illustrating an example display screen of the display section 3 in the first embodiment.

FIGS. 7A, 7B are drawings illustrating alternative example display screens of the display section 3 in the first embodiment.

FIG. 8 is a block diagram of the print order accepting apparatus according to a second embodiment of the present invention, illustrating the functional configuration thereof.

FIG. 9 is a drawing illustrating the data structure of the sound information in the second embodiment.

FIG. 10 is a flowchart illustrating the process flow of the imaged date and time correction in the second embodiment.

FIGS. 11A to 11C are drawings illustrating example frequency spectra of the sound data files in the second embodiment.

### DESCRIPTION OF THE PREFERRED EMBODIMENTS

Hereinafter, exemplary embodiments of the present invention will be described with reference to the accompanying drawings. The present invention will be described with reference to an example case in which the imaged date and time correction apparatus of present invention is applied to a print order accepting apparatus installed in a photo shop or the like. It should be appreciated that the present invention is also applicable to a personal computer having a display, and the like.

### First Embodiment

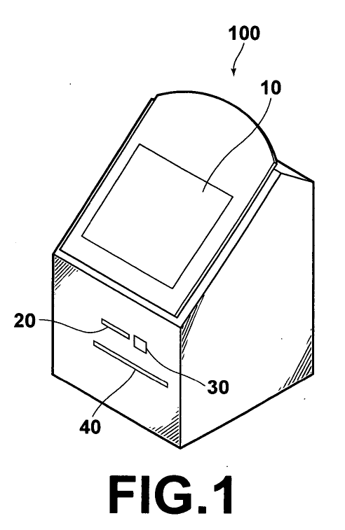

FIG. 1 is an external view of the print order accepting apparatus 100 according to a first embodiment of the present invention. The apparatus 100 is basically constituted by: a display 10 having a touch panel function; a memory slot 20; an I/O port 30; and a photo outlet 40. The I/O port 30 is provided for exchanging data with an external device, for example, a digital camera or a cell phone with a digital camera. It may be a port for connecting a cable terminal or an infrared port for exchanging data using infrared light.

When a memory card having image information including image data recorded thereon is inserted into the memory slot 20, or the digital output terminal of a digital camera having image information including image data recorded thereon is connected to the I/O port 30 by the user, and the image information is started to be outputted, the print order accepting apparatus 100 initiates downloading the image information. Then, it displays the images on the display 10 in chronological order based on the imaged date and time data included in the downloaded image information. Thereafter, an imaged date and time correction process or a printing process for the displayed images is performed by the user through touching the display 10 in accordance with the messages and buttons displayed thereon. When an image printing process is performed, the printed image is outputted from the photo outlet 40.

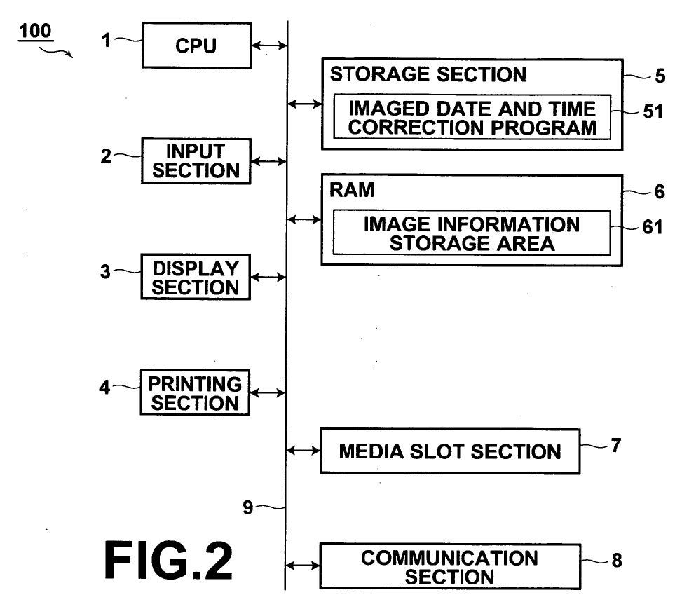

FIG. 2 is a block diagram of the print order accepting apparatus 100, illustrating the functional configuration thereof. As shown in FIG. 2, the print order accepting apparatus 100 is constituted by a CPU 1, an input section 2, a display section 3, printing section 4, a storage section 5, a RAM 6, a media slot section 7, and a communication section 8, which are connected to each other through a bus 9.

The CPU 1 (date and time correction means, corresponding date and time obtaining means, date and time difference detection means) performs various controls, including an image data recording control, an image display control, and the like, as well as controlling each of the elements constituting the print order accepting apparatus 100. More specifically, it reads out an imaged date and time correction program 51, and performs the correction process according to the program.

The input section 2 (selection means) is provided for inputting various instructions to the print order accepting apparatus 100, and constituted by a touch panel, a keyboard, a mouse, or the like. When the display 10 and touch panel is integrated as in the print order accepting apparatus 100 shown in FIG. 1, the touch panel and a location detection means (not shown) for detecting the coordinates of a depressed point on the touch panel correspond to the input section 2, and the coordinate information detected by the location detection means is outputted to the CPU 1.

The display section 3 (model identifier display means, image display means) is constituted by a cathode-ray tube, a liquid crystal display, or the like, and displays images, operation buttons, or the like according to the instruction signal outputted from the CPU 1. The display section 3 corresponds to the display 10 in FIG. 1.

The printing section 4 prints out images on papers, stickers, or the like, based on image data and according to the instruction signal outputted from the CPU 1. The printed out papers are outputted from the photo outlet 40 in FIG. 1.

The storage section 5 is a recording medium on which programs, data, and the like are prerecorded, which is constituted by a magnetic or optical recording medium, a semiconductor memory, or the like. The storage section 5 has stored therein the imaged date and time correction program 51 for correcting the imaged date and time data appended to image data files and the like, in addition to a system program (not shown) for operating the print order accepting apparatus 100.

The RAM 6 provides a work area for storing various programs to be executed by the CPU 1 and data related thereto, and an image information storage area 61, described later, for tentatively storing image information including image data downloaded through the media slot section 7 or communication section 8.

The media slot section 7 (image data downloading means, data downloading means) is constituted by an insertion slot (corresponding to the media slot 20 in FIG. 1) for inserting various memory cards, and a driver (not shown) for reading data from the memory card inserted in the insertion slot, or writing data thereon according to the instruction signal from the CPU 1. The image information read out from the memory card inserted in the media slot section 7 is stored in the image information storage area 61 of the RAM 6.

The communication section 8 (image data downloading means, data downloading means) is an interface for exchanging data with an external device such as a digital camera or the like, and constituted by a connection terminal for connecting a terminal of the cable connected to the external device, or an infrared port for exchanging data with the external device using infrared light, which corresponds to the I/O port 30 in FIG. 1.

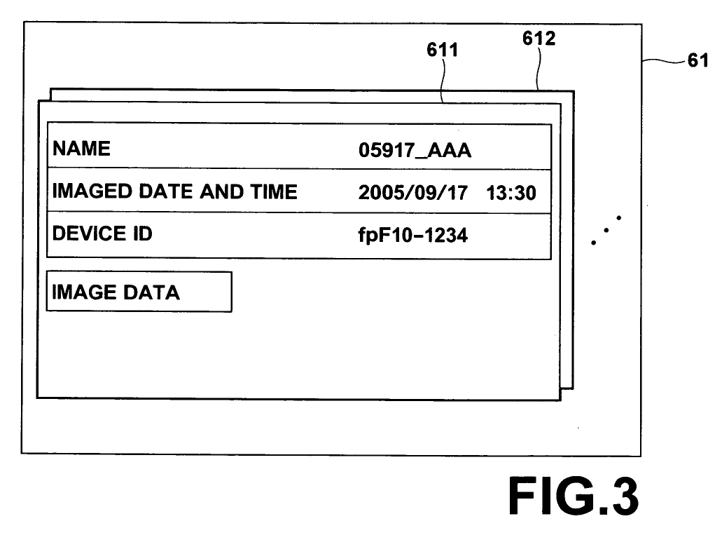

FIG. 3 is a drawing illustrating an example data structure of image information 611 stored in the image information storage area 61. The image information 611 includes an image data file with name data, recorded data and time data, and a device ID related thereto. The name data represent the file name of the image data file, and the imaged date and time data represent the date and time of the image data file. The device ID represents a unique number (model number, serial number, or the like) of the digital camera that obtained the image data file. The image information is created for each image data file as image information 611, image information 612, and so on, and stored in the image information storage area 61.

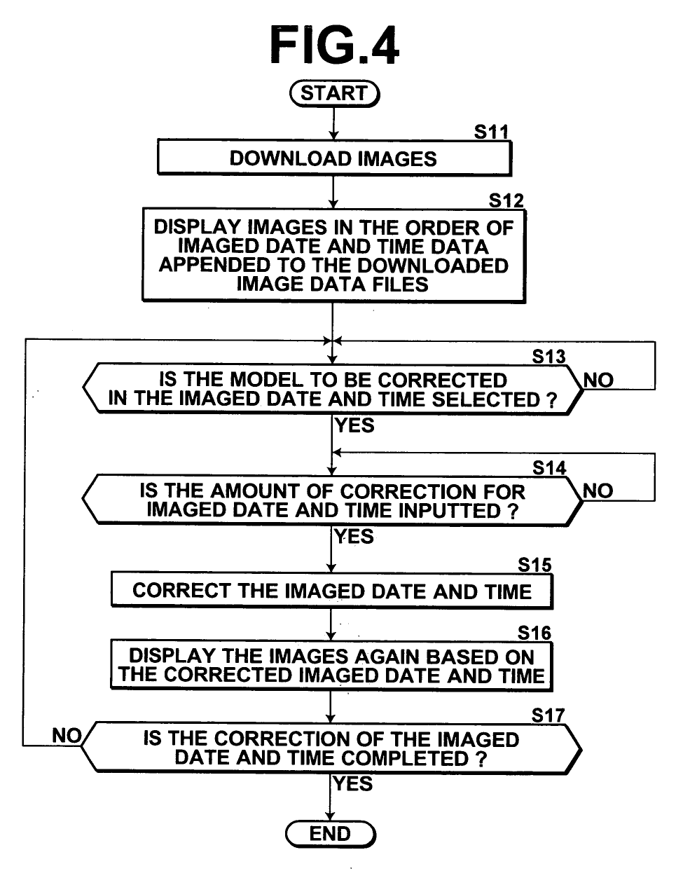

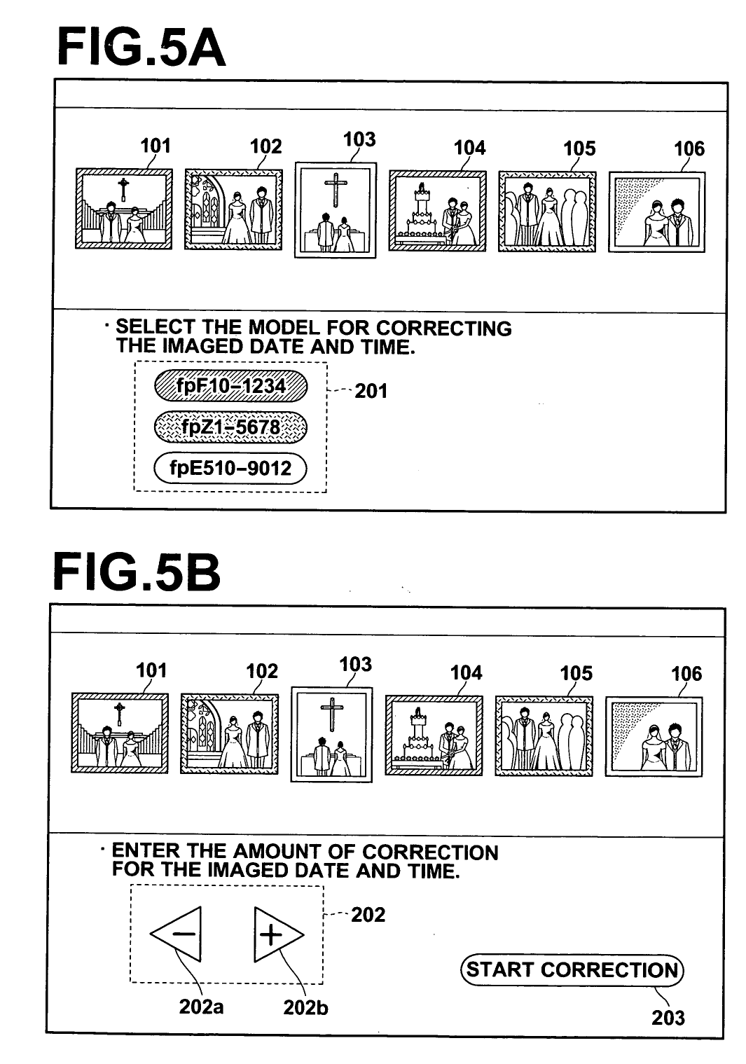

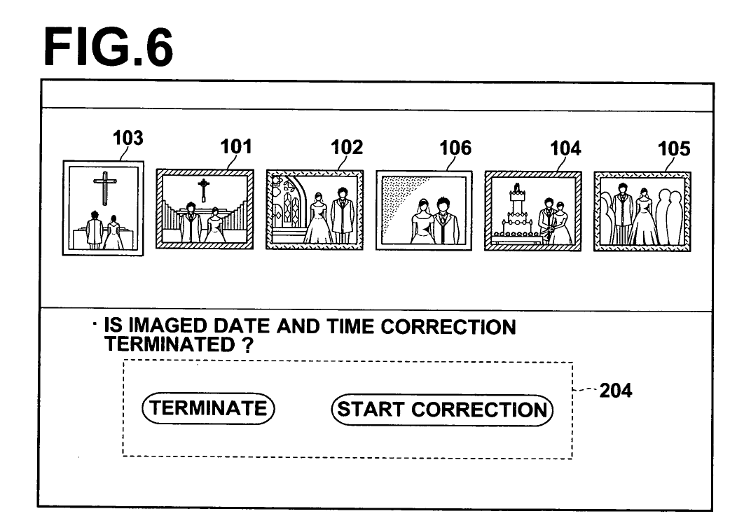

The imaged date and time correction process will now be described with reference to the flowchart shown in FIG. 4, and example display screens shown in FIGS. 5A, 5B, and 6. The imaged date and time correction process is performed by the CPU 1 operating in accordance with the imaged date and time correction program 51.

When a memory card or the like is inserted in the media slot section 7, or a terminal of the cable connected to a digital camera is connected to the communication section 8, image data files recorded on the memory card or digital camera, and the name data, recorded data and time data, and device IDs associated with the image data files are downloaded and stored in the image information storage area 61 (step S11).

Then, the CPU 1 causes the display section 3 to display images based on the image data included in the image information stored in the image information storage area 61. Here, the images are displayed in the order of date and time based on the imaged date and time data included in the image information (step S12). An example display screen of the display section 3 is shown in FIG. 5A. Images 101 to 106 are images of a wedding ceremony and reception obtained by three different digital cameras. Each image is displayed rimmed with a color or a pattern corresponding to the digital camera by which the image was obtained to allow distinction of which image was obtained by which digital camera. Alternatively, the imaged date and time, model name or device ID, and the like may be displayed adjacent to each image.

The images 101 to 106 shown in FIG. 5A are displayed in a line on the display 10 in ascending order of imaged date and time from right to left based on the imaged date and time data appended to the image data file corresponding to each image. If the date and time set on the three digital cameras are identical, the images 101 to 106 are displayed in the exact order of date and time in which the images were actually obtained. In actuality, however, the date and time set on either of the digital cameras may differ from others due to, for example, gaining/losing time of the digital camera, forgetting to reset them to Japan time after setting them to local time during overseas trip, or the like. If the date and time set on each of the digital cameras differs from each other in the manner as described above, the images 101 to 106 are not displayed in the exact order of date and time in which the images were actually obtained.

For example, if the date and time set on the digital camera that recorded the images 103 and 106 differs from the digital cameras that recorded the other images, the images 101 to 106 are not displayed in the exact order in which the wedding ceremony and reception actually took place. Consequently, the user determines if the images 101 to 106 displayed in the order based on the imaged date and time data are arranged correctly in the order the wedding ceremony and reception were actually took place. If the images 101 to 106 are not correctly arranged, the user finds out incorrectly arranged images, and selects the model of digital camera that obtained the incorrectly arranged images from selection buttons 201. The CPU 1 determines if either of the selection buttons 201 is selected (depressed) by the user (step S13). Here, the model names displayed on the selection buttons 201 may be device IDs included in the image information or common names corresponding to the device IDs. Alternatively, a configuration may be adopted in which selection of a single incorrectly arranged image causes all of the images obtained by the digital camera that obtained the incorrectly arranged image are selected instead of using the selection buttons 201 for the selection of the model of digital camera.

When the model of digital camera is selected (step S13 is positive), the CPU 1 causes the display section 3 to display an instruction button 202 for use by the user to instruct the amount of correction for the imaged date and time as shown in FIG. 5B. The instruction button 202 has, for example, a minus button 202a and a plus button 202b, and a single selection of the minus button 202a or plus button 202b causes a predetermined amount of time to be subtracted or added to the correction amount. Here, a configuration may be adopted in which the amount of time and/or number of days to be subtracted or added to the correction amount by a single selection of the minus button 202a or plus button 202b is selected by the user. Further, a configuration may be adopted in which a second button, a minute button, a time button, and day button are displayed beside the instruction button 202, and selection of the second button causes the correction amount to be changed by several seconds, and selection of the day button causes the imaged date and time data to be changed by one day. Still further, a configuration may be adopted in which the amount of correction is directly inputted by the user.

The CPU 1 determines if the instruction button 202 is selected, and a correction start button 203 is depressed by the user (step S14). If the correction start button 203 is determined to be depressed (step S14 is positive), the CPU 1 reads out each image information that includes the device ID corresponding to the model name of the digital camera selected in step S13 from the image information storage area 61, and equally corrects the imaged date and time data included in the image information based on the amount of correction instructed in step S14 (step S15).

Then, the CPU 1 causes the images 101 to 106 to be redisplayed in the order of date and time according to the corrected imaged date and time data (step S16). Further, the CPU 1 causes a selection button 204 to be displayed on the screen, which is used by the user for further correction of the imaged date and time if required. The user determines if the images 101 to 106 are arranged in the exact order of date and time in which the images were actually obtained, and if the result is positive, the user depresses the end button. If the end button is depressed (step S17 is positive), the CPU 1 terminates the process. On the other hand, if the recorrection button is selected (step S17 is negative), the CPU 1 causes the process to return to step S13.

At this point, the imaged date and time data appended to the image data files obtained by the digital camera selected by the user have been corrected and recorded in the image information stored in the image information storage area 61. The image information including the corrected imaged date and time data may be uploaded to the memory card or digital camera by overwriting.

In this way, in the present embodiment, images are displayed in the order of recorded data and time data based on the image data obtained by a plurality of digital cameras. Then, if the digital camera for correcting the imaged date and time data and the amount of correction are indicated by the user, the imaged date and time data appended to each of the image data files obtained by the indicated digital camera are equally corrected. Thus, the imaged date and time data appended to the image data files may be readily corrected. Further, no interface is required for exchanging information including current time or the like between the digital camera and the print order accepting apparatus 100, so that the present invention may be applied to an existing print order accepting apparatus. That is, there is no need to newly design a print order accepting apparatus, so that the cost for providing the service is minimized.

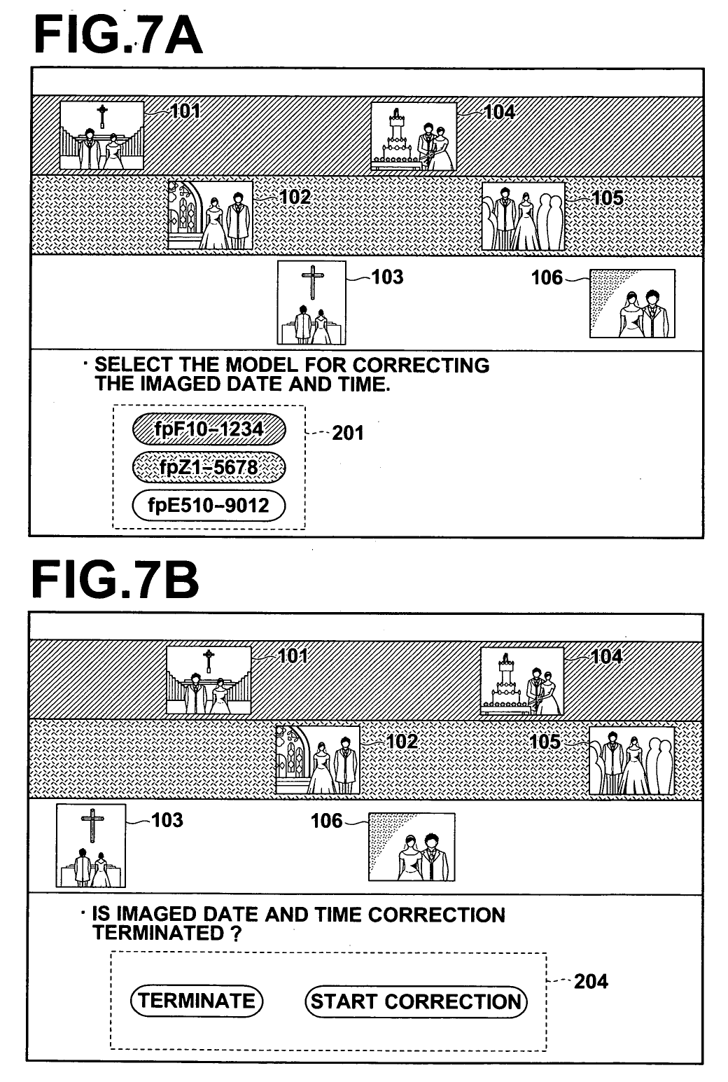

It should be appreciated that the present embodiment described above may be changed as appropriate without departing from the scope of the present invention. For example, when images are displayed on the display 10 based on the image data included in the image information stored in the image information storage area 61, the images are displayed in a line on the display 10 in the order indicated by the imaged date and time data appended to each image data file from right to left. In addition, the images are rimmed with respective colors, patterns, or the like allocated to the respective digital cameras that obtained the images. Images obtained by the respective digital cameras may be displayed separately as shown in FIGS. 7A, 7B. FIG. 7A illustrates an example screen display before the imaged date and time data are corrected. Images obtained by different digital cameras are displayed in different rows, and each image is arranged in the lateral direction (horizontal direction on the drawings) according to the imaged date and time. Then, the digital camera that obtained the images to which the user wishes to make correction in the imaged date and time and the amount of correction are indicated by the user. After the correction of the imaged date and time data, each image is redisplayed according to the corrected imaged date and time data as shown in FIG. 7B.

A configuration may be adopted in which the display form shown in FIGS. 5A, 5B, i.e., the images are displayed in a line, and the display form shown in FIGS. 7A, 7B, i.e., images recorded by different digital cameras are displayed on different rows, are selectable by the user, since some users may prefer the former and other users may prefer the latter display form.

Further, in the present embodiment, the amount of correction for the imaged date and time data is accepted through the instruction button 202. But, a configuration may be adopted in which an image to which the user wishes to make correction in the imaged date and time data is drag-dropped by the user, and the imaged date and time of all of the images obtained by the digital camera by which the drag-dropped image was obtained are corrected according to the dragged distance.

Still further, a configuration may be adopted in which images recorded by two different digital cameras at the same time are selected, and if the imaged date and time of the two images differ from each other, the amount of correction is inputted so that they correspond to each other, and the imaged date and time data appended to all of the image data files obtained by the digital camera that obtained the image data file corresponding to either image are collectively corrected. Alternatively, a configuration may be adopted in which the same scene is imaged by two different digital cameras at predetermined time interval. Then the images are selected, and an mount of correction is inputted so that the difference in the imaged date and time between the two images corresponds to the predetermined time interval, and the imaged date and time data appended to all of the image data files obtained by the digital camera that obtained either image are collectively corrected based on the amount of correction.

### Second Embodiment

In the first embodiment, description has been made in which images are displayed on the display 10 based on the imaged date and time data appended to the image data files downloaded to the print order accepting apparatus 100, then the model of digital camera for correcting the imaged date and time is selected and the amount of correction is inputted by the user, and the imaged date and time data appended to all of the image data files obtained by the selected digital camera are collectively corrected based on the amount of correction. In the second embodiment, a method for correcting the imaged date and time data using sound data files obtained by a plurality of digital cameras by recording the same sound at the same time.

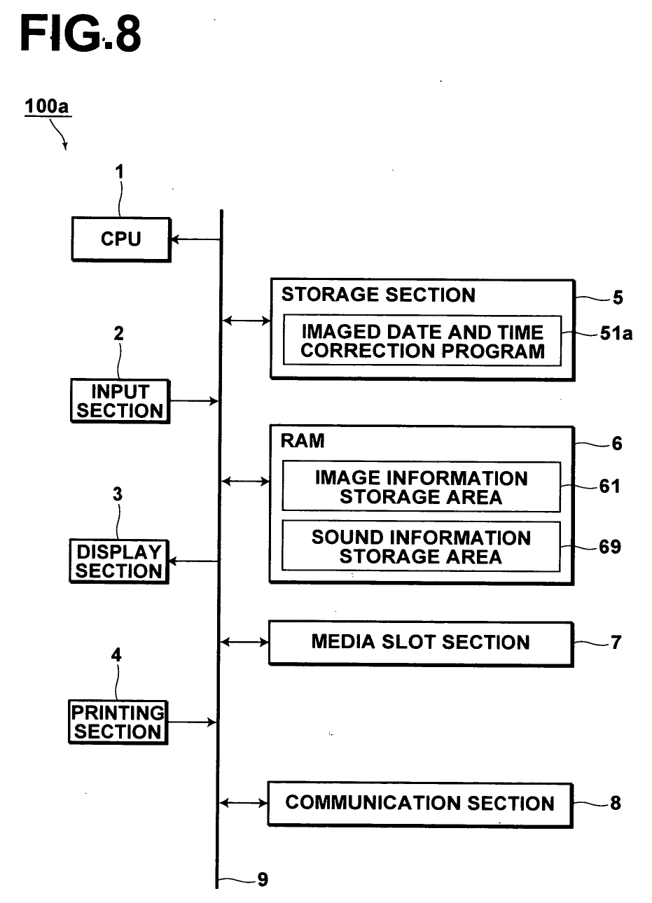

FIG. 8 is a block diagram of the print order accepting apparatus 100a according to the second embodiment of the present invention, illustrating the functional configuration thereof. The external view of the print order accepting apparatus 100a according to the second embodiment is identical to that of the print order accepting apparatus 100 according to the first embodiment. The components of the print order accepting apparatus 100a according to the second embodiment identical to those of the print order accepting apparatus 100 according to the first embodiment are given the same reference numerals, and will not be elaborated upon further. Here, only the different components and/or functions will be described.

The print order accepting apparatus 100a is constituted by the CPU 1, input section 2, display section 3, printing section 4, storage section 5, RAM 6, media slot section 7, and communication section 8, which are connected to each other through the bus 9.

The storage section 5 is a recording medium constituted by a magnetic or optical recording medium, a semiconductor memory, or the like, and programs, data, and the like are prerecorded thereon. The storage section 5 has stored therein an imaged date and time correction program 51a for correcting the imaged date and time that indicates the date and time of each of the image data files, based on sound data files, and the like, in addition to a system program (not shown) for operating the print order accepting apparatus 100a.

The RAM 6 provides a work area for storing various programs to be executed by the CPU 1 and data related thereto, and an image information storage area 61, described later, for tentatively storing image information including image data downloaded through the media slot section 7 or communication section 8. It also provides a sound information storage area 69 for tentatively storing sound information including sound data files downloaded through the media slot section 7 or communication section 8.

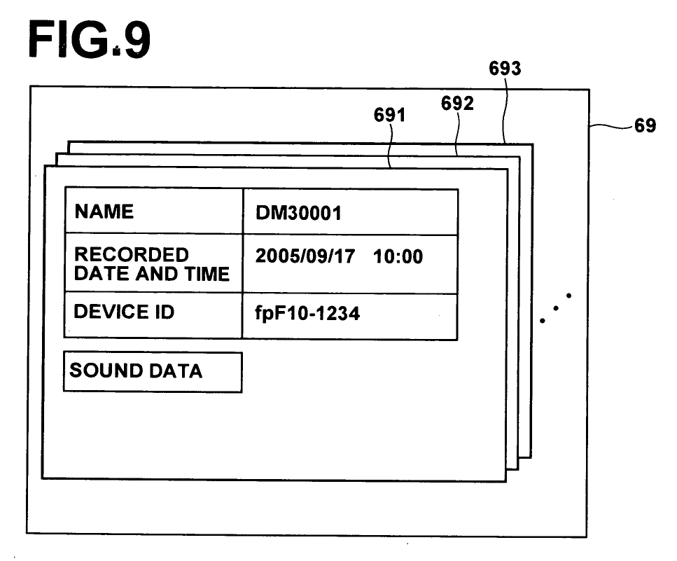

FIG. 9 is a drawing illustrating an example data structure of sound information 691 stored in the sound information storage area 69. The sound information 691 includes a sound data file with the name data, recorded data and time data, and a device ID related thereto. The sound data file is obtained by recording the same sound by a plurality of digital cameras having sound recording capability at the same time. The name data represent the file name of the sound data file, and the recorded date and time data represent the date and time of the sound data file. The device ID represents a unique number (model number, serial number, or the like) of the digital camera that obtained the sound data. The sound information is created for each imaging device as sound information 691, sound information 692, sound information 963, and so on, and stored in the sound information storage area 69.

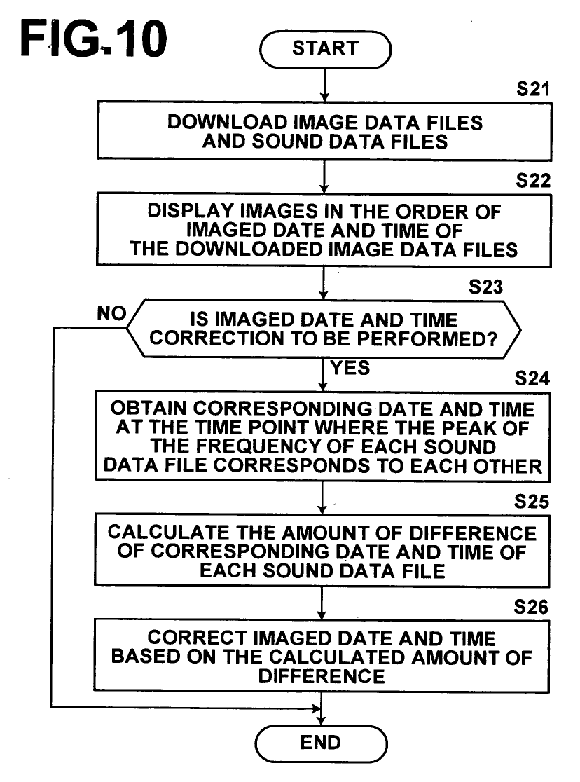

The imaged date and time correction process will now be described with reference to the flowchart shown in FIG. 10. The imaged date and time correction process is performed by the CPU 1 operating in accordance with the imaged date and time correction program 51a.

When a memory card or the like is inserted in the media slot section 7, or a terminal of the cable connected to a digital camera is connected to the communication section 8, image data files recorded on the memory card or digital camera, and the associated name data, recorded data and time data, device IDs, and the sound data files, and the associated name data, device IDs are downloaded, and the image data files and the associated various data are stored in the image information storage area 61, and the sound data files and the associated various data are stored in the sound information storage area 69 (step S21). Then, the CPU 1 causes the display section 3 to display images based on the image data files included in the image information stored in the image information storage area 61. Here, the images are displayed in the order of date and time based on the imaged date and time data included in the image information (step S22).

When an instruction to correct the imaged date and time of an image is inputted by the user (step S23 is positive), the CPU 1 reads out the sound data file recorded by each of the digital cameras from the sound information storage area 69, and extracts the time point where the peak of the frequency spectrum of each of the sound data files corresponds to each other. Then, the corresponding date and time at the corresponding time point is obtained based on the recorded date and time data appended to each of the sound data files (step S24).

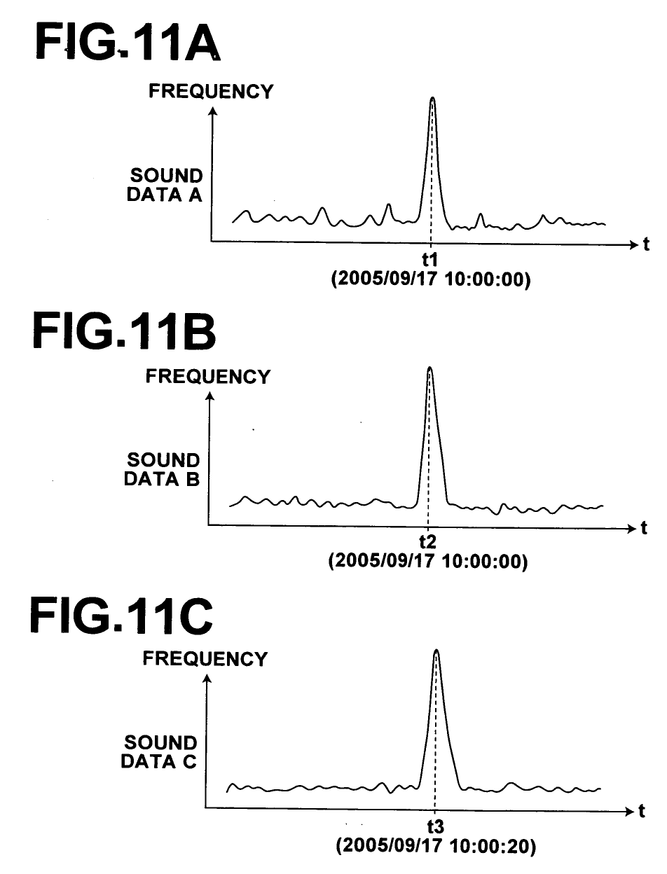

FIGS. 11A to 11C illustrate example frequency spectra of the sound data files obtained by three different digital cameras. For example, the frequency spectrum of sound data A recorded by a first digital camera is shown in FIG. 11A, that of sound data B obtained by a second digital camera is shown in FIG. 11B, and that of sound data C obtained by a third digital camera is shown in FIG. 11C. Since each of the sound data files is obtained by recording the same sound by the three different digital cameras at the same time, each of the frequency spectra is substantially identical to each other. Then, peaks of the frequency spectrum of each sound data file are detected to extract the peak that corresponds to all of the sound data files in the peak value and peak width. In the case shown in FIGS. 11A to 11C, the peak of the sound data A at time point t1, the peak of the sound data B at time point t2, and the peak of the sound data C at time point t3 are substantially correspond to each other in the peak value, peak width, and the like. Accordingly, each of the time points t1, t2, and t3 where each of the peaks occurred is deemed as the corresponding date and time. Then, the date and time indicated by the corresponding date and time is calculated from the recorded date and time data appended to each of the sound data files.

Here, if the date and time set on each of the digital cameras differs from each other, even if the same sound is recorded at the same time, the recorded date and time data differ from each other. That is, if the date and time set on each of the digital cameras are identical, the date and time of the peak of each of the sound data files is identical. If the date and time set on each of the digital cameras differs from each other, however, the corresponding date and time of each of the sound data files differs from each other. That is, if the date and time set on each of the digital cameras differs from each other, the peak of the same sound is recorded by the digital cameras as if the peak of the sound occurred at different time points.

A specific example will now be described. Assuming that date and time set on the first and second digital cameras are identical, and the time (corresponding date and time) at the time points t1 and t2 is calculated, for example, as “2005/09/17/10:00:00”. On the other hand, the date and time set on the third digital camera differs from the other two digital cameras, and the time (corresponding date and time) at the time point t3 is calculated, for example, as “2005/09/17/10:00:20”. Thus, the peak of the same sound is recorded by the third digital camera as if it occurred 20 second later. The amount of 20 second is deemed to be the amount of difference of the date and time set on the third digital camera from the date and time set on the first and second digital cameras.

Now returning to FIG. 10, after obtaining the corresponding date and time, where each of the peaks corresponds to each other, based on the recorded date and time data appended to each of the sound data files, the amount of difference of the corresponding date and time of each of the sound data files is calculated (step S25). Here, with reference to the corresponding date and time of the sound data file recorded by the digital camera selected by the CPU 1 based on a certain criterion (for example, digital camera that recorded the highest number of image data files, digital camera that comes on top of the list when device IDs are arranged in alphabetical order), the amount of difference of each of the sound data files recorded by other digital cameras may be calculated. Alternatively, a configuration may be adopted in which the reference digital camera is selected by the user, and the corresponding date and time of the sound data file recorded by the digital camera selected by the user is used as the reference.

Then, the CPU 1 equally corrects the imaged date and time data included in the image information that includes the device ID corresponding to the device ID appended to each of the sound data files based on the amount of difference of the corresponding date and time of each of the sound data files (step S26).

The imaged date and time data that have been corrected based on the peak of the frequency spectrum of each of the sound data files are recorded in the image information stored in the image information storage area 61. The image information including the corrected imaged date and time data may be uploaded to the memory card or digital camera by overwriting.

In this way, in the present embodiment, the same sound is recorded by a plurality of digital cameras at the same time, and the corresponding date and time of each of the sound data files, which is the time point where the peak of the frequency spectrum of each of the sound data files corresponds to each other, is obtained from the recorded date and time data to calculate the time difference of the corresponding date and time of each of the sound data files. Then, the imaged date and time data appended to the image data files are equally corrected based on the time difference. Thus, the imaged date and time data appended to the image data files may be readily corrected. Further, no interface is required for exchanging information including current time or the like between a digital camera and the print order accepting apparatus 100a, so that the present invention may be applied to the existing print order accepting apparatus. That is, there is no need to newly design a print order accepting apparatus, so that the cost for providing the service is minimized.

In the present embodiment, frequency spectrum is used as an example, for indicating a characteristic amount of the sound data. But the present invention is not limited to this, and any element indicating a characteristic amount of the sound data may be used as long as the time difference of the corresponding date and time is calculated from the characteristic amount.

What is claimed is:

1. An imaged date and time correction apparatus, comprising:
an image data downloading means for downloading image data files obtained by a plurality of imaging devices, each file having appended thereto date and time data that indicate the imaged date and time thereof;
a selection means for selecting all of the image data files obtained by either one of the plurality of imaging devices from the downloaded image data files; and
a date and time correction means for equally correcting the date and time data appended to the selected image data files.

2. The imaged date and time correction apparatus according to claim 1, wherein:
the apparatus further includes a model identifier display means for displaying a model identifier of each of the plurality of imaging devices; and
the selection means receives a selection instruction specifying either one of the displayed model identifiers, and selects all of the image data files obtained by the imaging device corresponding to the specified model identifier.

3. The imaged date and time correction apparatus according to claim 1, wherein:
the apparatus further includes an image display means for displaying images based on the downloaded image data files; and
the selection means receives a selection instruction specifying either one of the displayed images, and selects all of the image data files obtained by the imaging device that obtained the image data file corresponding to the specified image.

4. An imaged date and time correction apparatus, comprising:
a data downloading means for downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;
a corresponding date and time obtaining means for obtaining a corresponding date and time at the time point where a sound characteristic amount of each of the downloaded sound data files corresponds to each other for each of the sound data files from the recorded date and time data;
a date and time difference detection means for detecting a difference of the corresponding date and time of each of the sound data files based on the obtained corresponding date and time of each of the sound data files; and
a date and time correction means for equally correcting the date and time data appended to the image data files based on the detected difference of the corresponding date and time.

5. The imaged date and time correction apparatus according to claim 4, wherein:
the apparatus further includes a selection means for selecting either one of the plurality of imaging devices;
the date and time difference detection means detects a time difference between the corresponding date and time of the sound data file obtained by the selected imaging device and the corresponding date and time of the sound data file obtained by another of the imaging devices; and
the date and time correction means equally corrects the imaged date and time data appended to the image data files obtained by the another imaging device based on the detected time difference.

6. An imaged date and time correction method, comprising the steps of:
downloading image data files obtained by a plurality of imaging devices, each file having appended thereto date and time data that indicate the imaged date and time thereof;
selecting all of the image data files obtained by either one of the plurality of imaging devices from the downloaded image data files; and
equally correcting the date and time data appended to the selected image data files.

7. An imaged date and time correction method, comprising the steps of:
downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;
obtaining means for obtaining a corresponding date and time at the time point where a sound characteristic amount of each of the downloaded sound data files corresponds to each other for each of the sound data files from the recorded date and time data;
detecting a difference of the corresponding date and time of each of the sound data files based on the obtained corresponding date and time of each of the sound data files; and
equally correcting the date and time data appended to the image data files based on the detected difference of the corresponding date and time.

8. A program for causing a computer to execute the steps of:
downloading image data files obtained by a plurality of imaging devices, each file having appended thereto date and time data that indicate the imaged date and time thereof;
selecting all of the image data files obtained by either one of the plurality of imaging devices from the downloaded image data files; and
equally correcting the date and time data appended to the selected image data files.

9. A program for causing a computer to execute the steps of:
downloading image data files obtained by a plurality of imaging devices, each file having appended thereto imaged date and time data that indicate the imaged date and time thereof, and sound data files, each having appended thereto recorded date and time data that indicate the recorded date and time of a sound obtained when the sound was recorded by the plurality of imaging devices at the same time;
obtaining means for obtaining a corresponding date and time at the time point where a sound characteristic amount of each of the downloaded sound data files corresponds to each other for each of the sound data files from the recorded date and time data;
detecting a difference of the corresponding date and time of each of the sound data files based on the obtained corresponding date and time of each of the sound data files; and
equally correcting the date and time data appended to the image data files based on the detected difference of the corresponding date and time.
